(19) United States
(12) Patent Application Publication
(10) Pub. No.: US 2007/0121562 A1
(43) Pub. Date: May 31, 2007

(54) COMMUNICATION CONTROL SYSTEM AND METHOD THEREOF

(75) Inventors: CHENG-SHING LAI, TAIPEI CITY (TW); JUN-SHENG ZHANG, NANKING (CN); PING GU, NANKING (CN)

Correspondence Address: J C PATENTS, INC., 4 VENTURE, SUITE 250, IRVINE, CA, 92618, US

(73) Assignee: INVENTEC APPLIANCES CORP., TAIPEI (TW)

(21) Appl. No.: 11/562,273

(22) Filed: Nov. 21, 2006

(30) Foreign Application Priority Data
Nov. 25, 2005 (TW) 94141570

(51) Int. Cl. H04Q 7/24

(52) U.S. Cl. 370/338

(57) ABSTRACT

A communication control system applicable to a portable communication apparatus and a method thereof are disclosed. The communication control system includes a first communication module, a second communication module, a detector, and a controller. A first wireless signal is sent and received between the first communication module and a first base station via a first communication network. A second wireless signal is sent and received between the second communication module and a second base station via a second communication network. The detector detects the statuses of the first communication module and the second communication module. If one of the communication modules is detected being in communication, the detector triggers the controller to stop the other communication module from using the corresponding communication network.

### CROSS-REFERENCE TO RELATED APPLICATION

This application claims the priority benefit of Taiwan application serial no. 94141570, filed Nov. 25, 2005. All disclosure of the Taiwan application is incorporated herein by reference.

### BACKGROUND OF THE INVENTION

1. Field of the Invention

The present invention relates to a communication control system applicable to a portable communication apparatus and a method thereof. More particularly, the present invention relates to a system for detecting the status of a communication module so as to control another communication module and a method thereof.

2. Description of Related Art

A portable communication apparatus transmits communication signals via a communication network, thus, the user thereof can contact another party anywhere. Presently, communication networks which have been widely adopted include Global System for Mobile (GSM) and Personal Handyphone System (PHS). Generally speaking, PHS has lower cost and is more accordant to the concept of green mobile due to its low power technique. Besides, the signal coverage of PHS is limited while GSM has the advantages of broader signal coverage and clearer signals, thus, cell phones adapted to both networks have become more popular. However, dual mode cell phones have increased radiation and power consumption.

Even though a dual mode cell phone can use PHS of as lower power as possible through the function of call transfer, so as to reduce the radiation and power consumption thereof, when the dual mode cell phone is in communication by using PHS, the GSM module thereof is still in contact with the GSM server through wireless signals, and the radiation produced accordingly is still not resolved. As described above, how to reduce the radiation and power consumption of dual model cell phone has become the major subject of research.

A communication control system and method applicable to a portable communication apparatus are provide in the present invention to resolve the problems described above.

### SUMMARY OF THE INVENTION

Accordingly, the present invention is directed to provide a communication control system and a communication control method applicable to a portable communication apparatus, wherein the status of a communication module is detected and another communication module is controlled accordingly, so that the radiation and power consumption of the portable communication apparatus at communication can be reduced.

As embodied and broadly described herein, the present invention provides a communication control system including at least a first communication module, a second communication module, a detector, and a controller. The first communication module sends/receives at least a first wireless signal to/from at least a first base station via a first communication network, and the second communication module sends/receives at least a second wireless signal to/from at least a second base station via a second communication network. The detector detects the statuses of the first communication module and the second communication module so as to obtain a detection data. The controller controls the first communication module and the second communication module according to the detection data. As described above, if the detector detects that the first communication module is in communication, the controller controls the second communication module to stop using the second communication network according to the detection data, accordingly the contact between the portable communication apparatus and the second base station is terminated. If the detector detects that the second communication module is in communication, the controller controls the first communication module to stop using the first communication network according to the detection data, accordingly the contact between the portable communication apparatus and the first base station is terminated. As described above, the radiation and power consumption of the portable communication apparatus at communication can be reduced.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a communication control system applicable to a portable communication apparatus according to the present invention.

FIG. 2 is a flowchart illustrating a communication control method applicable to a portable communication apparatus according to the present invention.

FIG. 3 is a flowchart illustrating the communication control when a first communication network is used to send a conversation request and further to perform the conversation according to the present invention.

FIG. 4 is a flowchart illustrating the communication control when a first communication network is used to receive a conversation request and further to perform the conversation according to the present invention.

FIG. 5 is a flowchart illustrating the communication control when a second communication network is used to send a conversation request and further to perform the conversation according to the present invention.

FIG. 6 is a flowchart illustrating the communication control when a second communication network is used to receive a conversation request and further to perform the conversation according to the present invention.

### DESCRIPTION OF EMBODIMENTS

The communication control system and method in the present invention will be described and become more apparent from the detailed description of exemplary embodiments when read in conjunction with accompanying drawings.

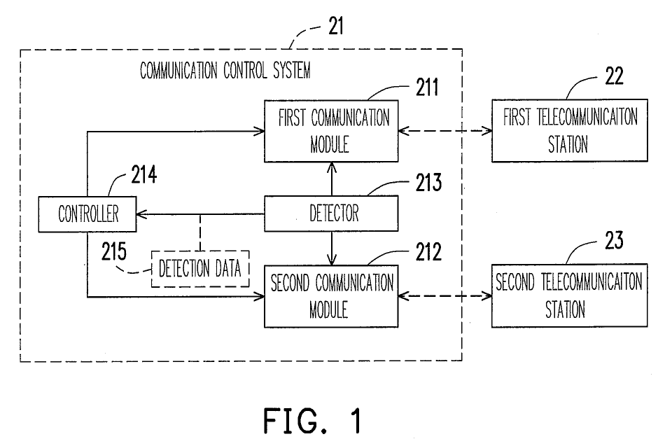

FIG. 1 is a diagram of a communication control system applicable to a portable communication apparatus according to the present invention. Referring to FIG. 1, the communication control system 21 includes a first communication module 211, a second communication module 212, a detector 213, and a controller 214. The first communication module 211 uses a first communication network for sending/receiving a first wireless signal to/from a first base station 22 so that the portable communication apparatus keeps in contact with the first base station 22, wherein the first communication network may be a Global System for Mobile (GSM). The second communication module 212 uses a second communication network for sending/receiving a second wireless signal to/from a second base station 23 so that the portable communication apparatus keeps in contact with the second base station 23, wherein the second communication network may be a Personal Handyphone System (PHS). The detector 213 detects the statuses of the first communication module 211 and the second communication module 212 to obtain a detection data 215. The controller 214 controls the first communication module 211 or the second communication module 212 according to the detection data 215.

As described above, if the detector 213 detects that the first communication module 211 is in communication, the controller 214 controls the second communication module 212 to stop using the second communication network according to the detection data 215 so that the contact between the portable communication apparatus and the second base station 23 is terminated, while if the detector 213 detects that the first communication module 211 has stopped communicating, the controller 214 controls the second communication module 212 to use the second communication network so that the contact between the portable communication apparatus and the second base station 23 is resumed. Or, if the detector 213 detects that the second communication module 212 is in communication, the controller 214 controls the first communication module 211 to stop using the first communication network according to the detection data 215 so that the contact between the portable communication apparatus and the first base station 22 is terminated, while if the detector 213 detects that the second communication module 212 has stopped communicating, the controller 214 controls the first communication module 211 to use the first communication network so that the contact between the portable communication apparatus and the first base station 22 is resumed. The communication operation may be sending a conversation request and further performing the conversation, or receiving a conversation request and further performing the conversation.

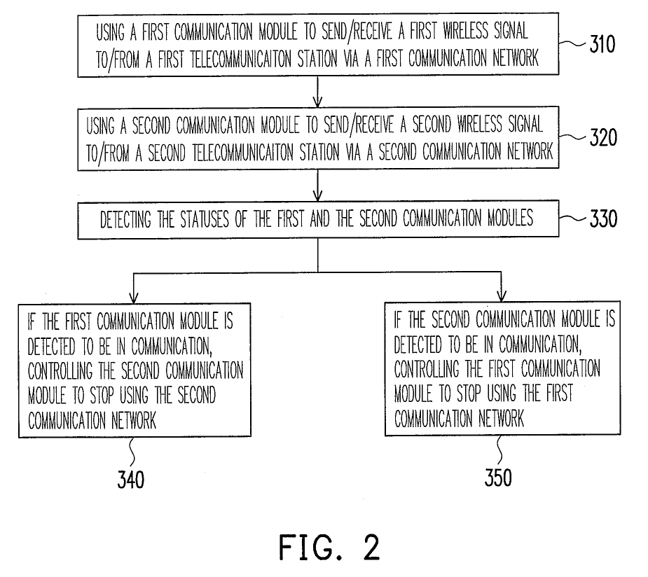

FIG. 2 is a flowchart illustrating a communication control method applicable to a portable communication apparatus according to the present invention. Referring to FIG. 2, the method includes following steps. First, a first communication module is used to send/receive a first wireless signal to/from a first base station via a first communication network (step 310), so that the portable communication apparatus keeps in contact with the first base station, wherein the first communication network is a GSM. A second communication module is used to send/receive a second wireless signal to/from a second base station via a second communication network (step 320), so that the portable communication apparatus keeps in contact with the second base station, wherein the second communication network is a PHS. The statuses of the first communication module and the second communication module are detected (step 330). If the first communication module is detected to be in communication, the second communication module is controlled to stop using the second communication network (step 340) so that the second communication module cannot send/receive the second wireless signal to/from the second base station, accordingly the contact between the portable communication apparatus and the second base station is terminated, wherein the communication operation may be sending a conversation request and further performing the conversation or receiving a conversation request and further performing the conversation. If the second communication module is detected to be in communication, the first communication module is controlled to stop using the first communication network (step 350) so that the first communication module cannot send/receive the first wireless signal to/from the first base station, accordingly the contact between the portable communication apparatus and the first base station is terminated. Accordingly, the purpose of terminating another communication network at conversation can be accomplished.

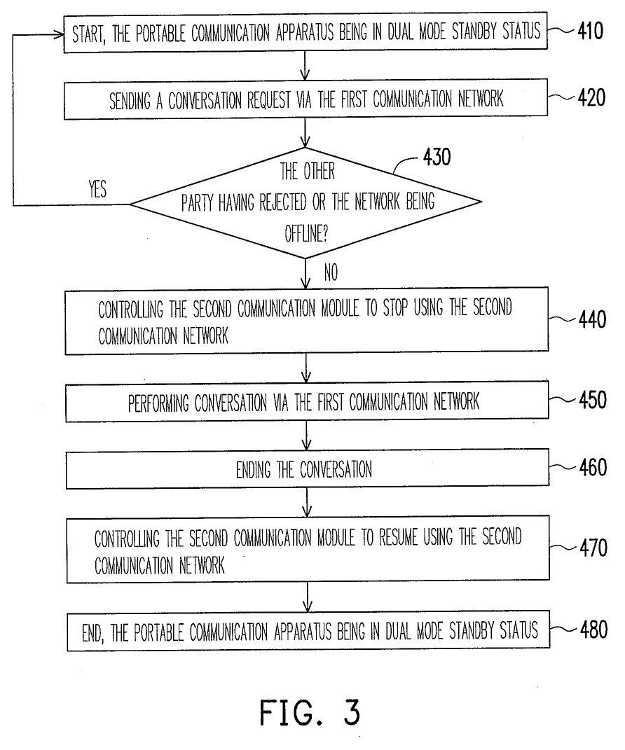

FIG. 3 is a flowchart illustrating the communication control when a first communication network is used to send a conversation request and further to perform the conversation according to the communication control method in the present invention. Referring to FIG. 3, following steps are included:
step 410: start, the portable communication apparatus being in dual mode standby status;
step 420: sending a conversation request via the first communication network;
step 430: judging whether the other party having rejected the request or the network being offline, if so, returning to step 410, otherwise proceeding to step 440;
step 440: controlling the second communication module to stop using the second communication network;
step 450: performing conversation via the first communication network;
step 460: ending the conversation;
step 470: controlling the second communication module to resume using the second communication network; and
step 480: end, the portable communication apparatus being in dual mode standby status.

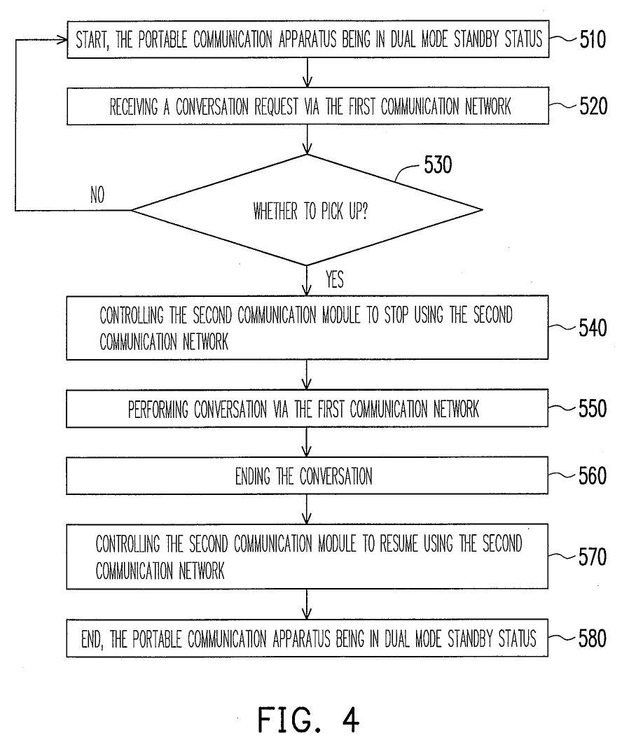

FIG. 4 is a flowchart illustrating the communication control when a first communication network is used to receive a conversation request and further to perform the conversation according to the communication control method in the present invention. Referring to FIG. 4, following steps are included:
step 510: start, the portable communication apparatus being in dual mode standby status;
step 520: receiving a conversation request via the first communication network;
step 530: judging whether to pick up, if so, performing step 540, otherwise returning to step 510;
step 540: controlling the second communication module to stop using the second communication network;
step 550: performing conversation via the first communication network;
step 560: ending the conversation;
step 570: controlling the second communication module to resume using the second communication network; and
step 580: end, the portable communication apparatus being in dual mode standby status.

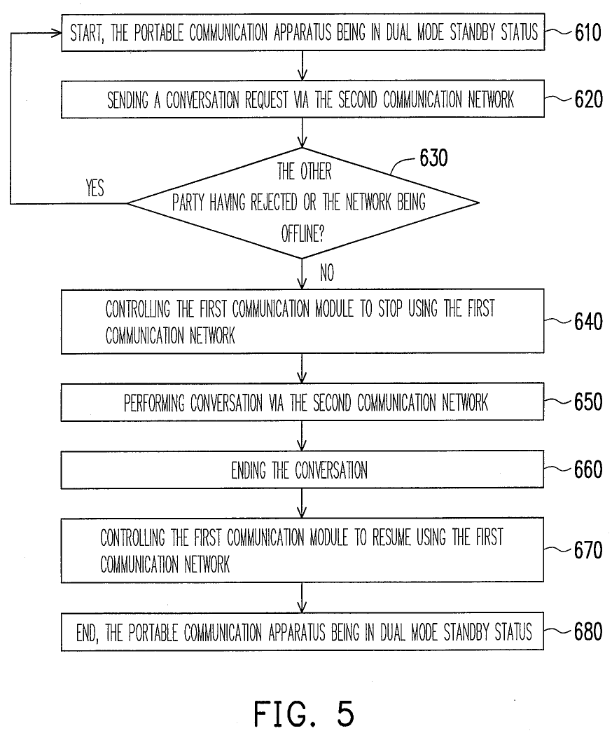

FIG. 5 is a flowchart illustrating the communication control when a second communication network is used to send a conversation request and further to perform the conversation according to the communication control method in the present invention. Referring to FIG. 5, following steps are included:
step 610: start, the portable communication apparatus being in dual mode standby status;
step 620: sending a conversation request via the second communication network;
step 630: judging whether the other party having rejected or the network being offline, if so returning to step 610, otherwise proceeding to step 640;
step 640: controlling the first communication module to stop using the first communication network;
step 650: performing conversation via the second communication network;
step 660: ending the conversation;
step 670: controlling the first communication module to resume using the first communication network; and
step 680: end, the portable communication apparatus being in dual mode standby status.

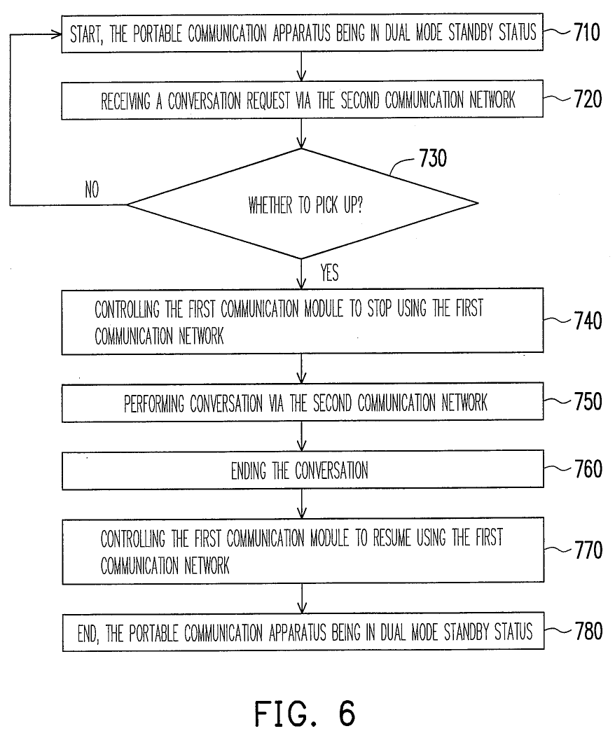

FIG. 6 is a flowchart illustrating the communication control when a second communication network is used to receive a conversation request and further to perform the conversation according to the communication control method in the present invention. Referring to FIG. 6, following steps are included:
step 710: start, the portable communication apparatus being in dual mode standby status;
step 720: receiving a conversation request via the second conununication network;
step 730: judging whether to pick up, if so, performing step 740, otherwise returning to step 710;
step 740: controlling the first communication module to stop using the first communication network;
step 750: performing conversation via the second communication network;
step 760: ending the conversation;
step 770: controlling the first communication module to resume using the first communication network; and
step 780: end, the portable communication apparatus being in dual mode standby status.

The foregoing description is only exemplary but not for limiting the present invention. Various changes in form and details may be made therein without departing from the spirit and scope of the present invention as defined by the following claims.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A communication control system applicable to a portable communication apparatus, the system comprising at least:
a first communication module, sending/receiving at least a first wireless signal to/from at least a first base station via a first communication network;
a second communication module, sending/receiving at least a second wireless signal to/from at least a second base station via a second communication network;
a detector, detecting the statuses of the first communication module and the second communication module to obtain a detection data; and
a controller, controlling the first communication module and the second communication module according to the detection data;
wherein when the detection data denotes that the first communication module is in communication, the controller stops the second communication module from using the second communication network, or when the detection data denotes that the second communication network is in communication, the controller stops the first communication module from using the first communication network.

2. The communication control system as claimed in claim 1, wherein the first communication network is a Global System for Mobile (GSM).

3. The communication control system as claimed in claim 1, wherein the second communication network is a Personal Handyphone System (PHS).

4. The communication control system as claimed in claim 1, wherein the first communication network is a GSM and the second communication network is a PHS.

5. The communication control system as claimed in claim 1, wherein the communication is to send a conversation request and further to perform the conversation.

6. The communication control system as claimed in claim 1, wherein the communication is to receive a conversation request and further to perform the conversation.

7. A communication control method applicable to a portable communication apparatus, the method comprising steps of:
using a first communication module to send/receive at least a first wireless signal to/from at least a first base station via a first communication network;
using a second communication module to send/receive at least a second wireless signal to/from at least a second base station via a second communication network;
detecting the statuses of the first communication module and the second communication module;
if the first communication module being in communication, controlling the second communication module to stop using the second communication network; and
if the second communication module being in communication, controlling the first communication module to stop using the first communication network.

8. The communication control method as claimed in claim 7, wherein the first communication network is a GSM.

9. The communication control method as claimed in claim 7, wherein the second communication network is a PHS.

10. The communication control method as claimed in claim 7, wherein the first communication network is a GSM and the second communication network is a PHS.

11. The communication control method as claimed in claim 7, wherein the communication is to send a conversation request and further to perform the conversation.

12. The communication control method as claimed in claim 7, wherein the communication is to receive a conversation request and further to perform the conversation.
